(19) United States
(12) Patent Application Publication
(10) Pub. No.: US 2018/0141283 A1
(43) Pub. Date: May 24, 2018

(54) PACKAGING MACHINE FOR PRODUCING AND FILLING MULTIPLE TYPES OF BAGS

(71) Applicant: VIKING MASEK, a.s., Praha 7 (CZ)

(72) Inventor: LUKAS MASEK, Vlasim (CZ)

(73) Assignee: VIKING MASEK a.s, Praha 7 (CZ)

(21) Appl. No.: 15/814,065

(22) Filed: Nov. 15, 2017

(30) Foreign Application Priority Data
Nov. 21, 2016 (CZ) 2016-33067 U

(51) Int. Cl. B29C 65/00; B65B 51/30; B65B 9/207; B65B 9/213; B65B 9/20

(52) U.S. Cl. CPC B29C 66/8491; B29C 66/43129; B65B 9/2056; B65B 9/207; B65B 9/213; B65B 51/30

(57) ABSTRACT

Packaging machine that can produce and fill bags, both flat and welded on three sides, with minimum demands for machine modifications in case of transition from producing and filling one type of bag to producing and filling another type of bag.

### FIELD OF THE INVENTION

The technical solution concerns packaging machines that can produce and fill bags, both flat and welded on three sides, with minimum demands for machine modifications in case of transition from producing and filling one type of bag to producing and filling another type of bag.

### BACKGROUND ART

Current packaging machines for flat bags and, at the same time, for bags welded on three sides are designed as a conversion-type. It means that conversion of the mechanism of transverse jaws designed to produce transverse welds is necessary for each individual type of bag, specifically by rotating the mechanism by 90°. The longitudinal welding jaw also needs to be replaced on the machine. The rotating mechanism, adjusted for such a change, is complex, and therefore can only be used on stepper machines. And the machines with this rotating mechanism are bigger in size. For continuous machines, where the mechanism must perform parallel vertical movement, the rotating mechanism is too heavy and, as such, inconvenient for continuous operation.

Some solutions to the issues of packaging machines outlined above are known, for example CZ patent No. 291679 deals with the production of transverse welds in the manufacture of bags. It employs transverse jaws and an adjustment required for separating individual bags. However, it only addresses the method of welding and the separation of individual bags. It does not address the possibility of production of flat bags and bags welded on three sides on a single machine without repositioning the jaws. Invention application No. CZ 1996-3412 refers to the production of bags and their filling with goods. In that application the dispensing tube is separated from the welding jaws. Vibration is transmitted to the dispensing tube through a vibration generator to compact the dispensed goods. This file does not in any way address the production of flat bags and bags welded on three sides using a single machine, without converting the machine. CZ utility model No. 18574 deals with bag production using continuous and stepper modes. It also addresses the production of welded edges on the bag. It even suggests the possible synchronous operation of individual machine assemblies, but still only applies to either flat bags, or bags with welded edges. Once again, this utility model does not address the possibility of production of both flat bags and bags welded on three sides using a single machine, without converting the machine. And CZ utility model No. 16233 addresses the production of welded edges on bags. The essence of the solution in that file is the on-site production of welded edges using a mechanism for unwinding the initial film strip by means of forming sheets or forming discs. The utility model deals only with bags with welded edges but does not address the possibility of production of flat bags and, at the same time, bags welded on three sides using a single machine, without converting the machine. And CZ utility model No. 12980 addresses the production of bags with a flat bottom on a vertical tubular machine. The flat, folded bottom of the bag is created using two opposing loading pulleys. It also addresses the removal of the finished bag from the area of transverse jaws to make room for the following bag, but once again fails to deal with the possibility of production of both flat bags and bags welded on three sides using a single machine, without converting the machine. It is evident from the published application WO 2005/025993 A1 that it deals with the production of welded edges on bags. Based on that file, the welded edges are made on a tube and the file also indicates a solution for different types of overlaps of the longitudinal weld. However, it does not in any way address the production of flat bags and bags welded on three sides using a single machine, without converting the machine. Lastly, the published application WO 02/16208 A1 deals with longitudinal welding using a machine operating in continuous mode. The essence of the application consists in the longitudinal weld being welded by hot air. The air is heated and fed onto the moving film by a nozzle. This creates a longitudinal weld under continuous operation. Once again, however, it does not in any way address the production of flat bags and bags welded on three sides using a single machine, without converting the machine.

None of the above-mentioned patent documents contain machine conversion to address the transition from one type of bag to another type of bag, which is an advantage of the present technical solution.

The advantage of the proposed technical solution is its minimum need for machine conversion in case of transition to another type of bag and the related speed of conversion and a layout that does not enlarge the machine, i.e. without taking up more space.

### SUMMARY OF THE INVENTION

The described disadvantages are substantially addressed by a packaging machine for producing and filling multiple types of bags, which in practice refers to flat bags, bags welded on three sides and Doy bags, wherein the machine contains a film container and its guiding mechanism and longitudinal and transverse welding jaws and wherein the essence consists in the machine being designed so that the the axis of transverse welding jaws is rotated by 45° vs. the vertical longitudinal plane of the packaging machine, where the by the tube supplied film feeding axis lies, with transverse welding jaws installed on device for clamping and opening transverse welding jaws.

The bag is thus welded and the machine designed in this way does not need any conversion mechanisms. The mechanisms in the machine remain firmly mounted within the machine frame and need not be rotated or otherwise repositioned. This means that the machine can produce flat bags as well as bags welded on three sides without converting the mechanism. The entire device for clamping and opening transverse welding jaws is preferably installed in a sliding arrangement on vertical bars to allow movement of the entire drive of the transverse welding jaws up and down. This makes it possible to set transverse welding synchronously with the moving film on the machine. This works in continuous mode. The vertical drive of the transverse welding jaws need not be used, i.e. it can be shut down in any position of the vertical stroke. In that case the transverse welding haws do not run synchronously with the moving film, which results in stepper, or discontinuous, mode.

To produce flat bags, the machine is preferably fitted with a collared tube whose longitudinal weld-creating axis is on the same plane as the plane of the transverse welding jaw. This makes it possible to produce flat bags.

To produce bags welded on three sides, the machine is preferably fitted with a collared tube whose longitudinal weld-creating axis is perpendicular to the axis of the transverse welding jaws. This allows production of a longitudinal weld on a bag welded on three sides. To produce Doy bags, the machine is preferably fitted with a collared tube whose longitudinal weld-creating axis is perpendicular to the axis of the transverse welding jaws. This makes it possible to produce a longitudinal weld on a bag welded on three sides. Compared to three-sided bags, a bottom interlay is also added. In general, all types of bags can be made without rotating the jaws, merely by replacing the tube; only the longitudinal welding jaws are replaced. Longitudinal welding jaws are chosen according to the machine mode either as continuous or stepper type.

### BRIEF DESCRIPTION OF THE DRAWINGS

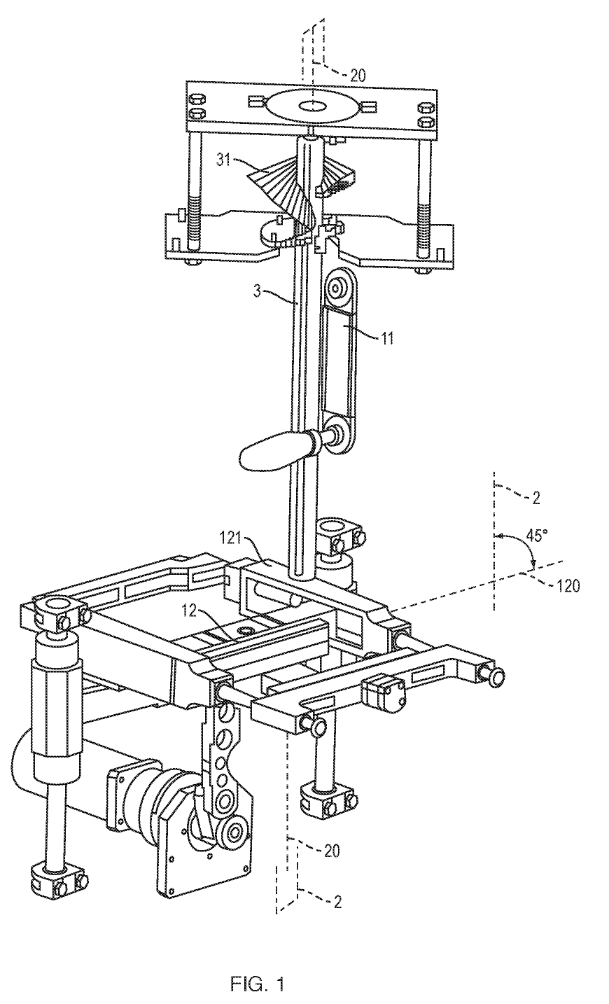

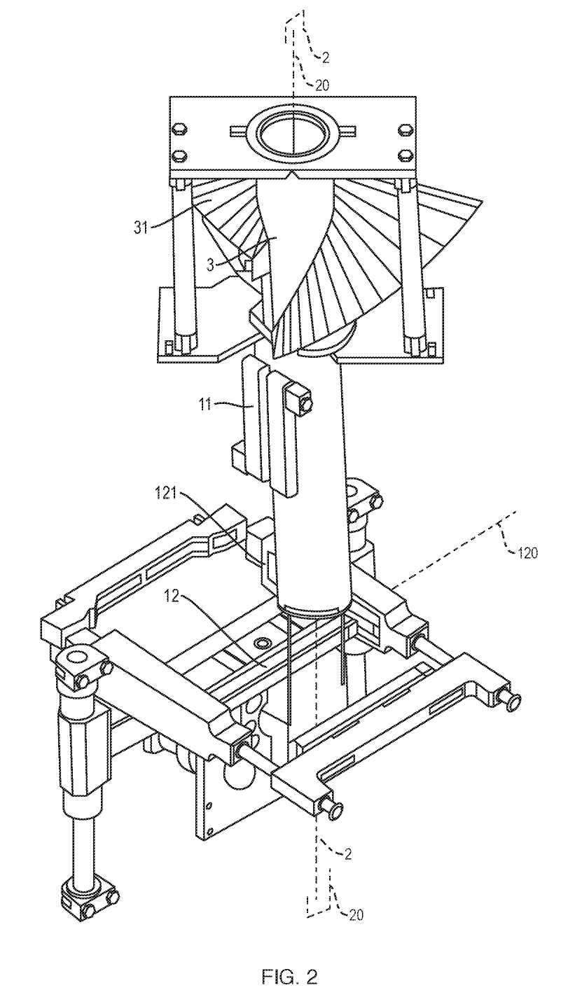

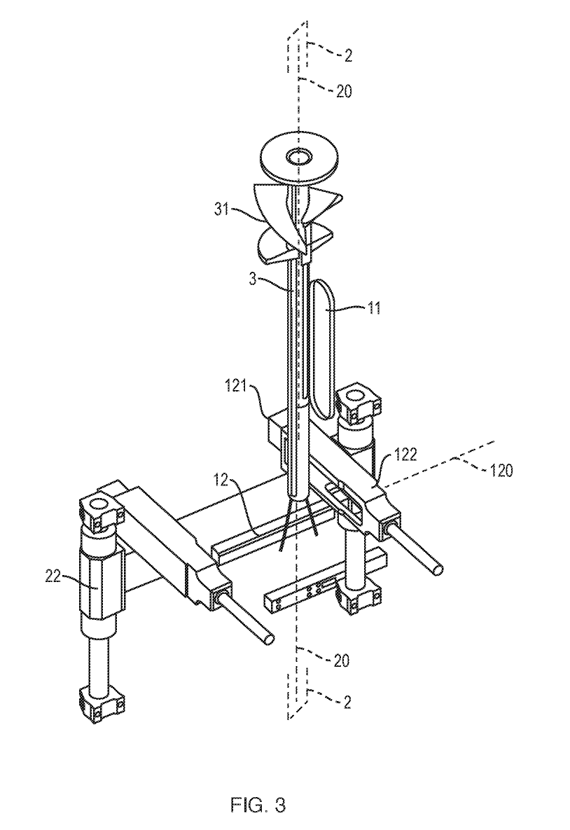

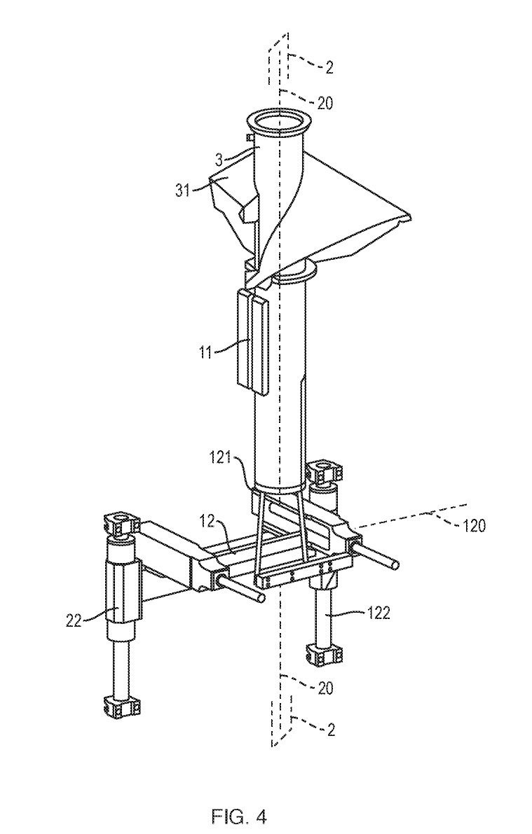

The technical solution is described and explained in greater detail on an embodiment, using also the attached drawings, wherein FIG. 1 shows a perspective view of the mechanism for strip guiding and setting of welding jaws on a machine for flat bags and FIG. 2 shows a perspective view of the mechanism for strip guiding and setting of welding jaws on a machine set to produce and fill bags welded on three sides and Doy bags, and wherein FIG. 3 shows an analogous, schematized view of the same mechanism as in FIG. 1, i.e. for flat bags, and FIG. 4 shows a schematized view of the mechanism as in FIG. 2, i.e. for three-sided bags and Doy bags, plus FIG. 5 with a perspective view of a flat bag, FIG. 6 with a perspective view of a bag welded on three sides and finally FIG. 7 with a perspective view of a Doy bag.

### DETAILED DESCRIPTION OF THE PREFERRED EMBODIMENT

### Embodiment 1

A specific embodiment of the universal vertical packaging machine, arranged in accordance with the present technical solution, for producing and filling flat bags, bags welded on three sides and Doy bags without any principal machine conversions, is described below.

The said packaging machine includes a film container, not shown here, and its guiding mechanism 1 and longitudinal welding jaws 11 as well as transverse welding jaws 12, wherein it is essential that the machine is designed so that the axis 120 of transverse welding jaws 12 is rotated by 45° vs. the vertical longitudinal plane 2 of the packaging machine, where the by the tube supplied film feeding axis 20 lies, with transverse welding jaws installed on device for clamping and opening transverse welding jaws.

Transverse welding jaws 12 are placed on device 121 for clamping and opening these transverse welding jaws 12. The entire device 121 for clamping and opening transverse welding jaws 12 is installed in a sliding arrangement on vertical bars 122, adjusted for the movement of the entire drive, or device 121 for clamping and opening transverse welding jaws 12, up and down, synchronously with the continuously moving film. With such a synchronous movement the machine can work in continuous mode. However, the vertical drive of transverse welding jaws 12 is detachable, with an adjustment for shut-down in any position of the vertical stroke. In this way the machine can also operate in discontinuous mode, if desired. In the settings for producing flat bags 21, tube 3 with collar 31 of tube 3 is mounted on the described machine; its longitudinal weld-creating axis is on the same plane as the plane of transverse welding jaw 12.

### Embodiment 2

In the second setting option for a machine with an analogous design, i.e. for producing bags welded on three sides 22, specifically for producing a longitudinal weld on bag welded on three sides 22, tube 3 with tube collar 31 is mounted on the machine and its longitudinal weld-creating axis is perpendicular to the axis 120 of transverse welding jaws 12.

### Embodiment 3

For another, third option of use, constituting a configuration or settings of the described packaging machine for producing Doy bags 23, tube 3 with tube collar 31 is mounted on the machine, otherwise designed analogously with embodiments 1 and 2, and its longitudinal weld axis is perpendicular to the axis 120 of transverse welding jaws 12, with a modification for producing longitudinal welds on bags welded on three sides 22, with a bottom interlay added vs. the three-sided bag.

In this manner the presented embodiments result in a packaging machine with high variability of use, wherein the machine remains compact, with smaller dimensions and easier steps for machine change to produce and fill another type of bag compared to a similar machine with a rotating mechanism.

### INDUSTRIAL APPLICABILITY

The packaging machine according to the present invention is useful for producing bags and for packaging goods in such bags. The bags are filled by the dispensing device when the bag is closed by the lower weld and before it is closed by the upper weld, with the dispensing and filling operations being provided by a common dispensing and filling device which is not in itself the subject of this invention. Its improved usability compared to existing machines of a similar purpose consists in the smaller dimensions of the machine, simpler overall design and easier operation when setting the machine to a different type of the produced and filled bag.

### LIST OF REFERENCE SYMBOLS

1—guiding mechanism
2—vertical longitudinal plane of the packaging machine
20—film feeding axis
11—longitudinal welding jaws
12—transverse welding jaws
120—axis of transverse welding jaws
121—device for clamping and opening transverse welding jaws
122—vertical bars
21—flat bag
22—bag welded on three sides
23—Doy bag
3—tube
31—tube collar

1. A packaging machine for producing and filling multiple types of bags, wherein the machine incorporates a film container and its guiding mechanism and longitudinal and transverse welding jaws, characterized in that the axis (120) of transverse welding jaws (12) is rotated by 45° vs. the vertical longitudinal plane (2) of the packaging machine, where the by the tube (3) supplied film feeding axis (20) lies, with transverse welding jaws (12) installed on device (121) for clamping and opening transverse welding jaws (12).

2. The packaging machine as in claim 1, where in the entire device (121) for clamping and opening transverse welding jaws (12) is installed in a sliding arrangement on vertical bars (122), adjusted for the movement of the device (121) for clamping and opening transverse welding jaws (12), up and down, synchronously with the continuously moving film.

3. The packaging machine as in claim 2, where in the device (121) for clamping and opening transverse welding jaws (12) is detachable, with an adjustment for shut-down in any position of the vertical stroke.

4. The packaging machine as in claim 1, where in tube (3) with collar (31) of tube (3) is mounted on the machine for producing flat bags (21) and its longitudinal weld-creating axis is on the same plane as the plane of transverse welding jaw (12).

5. The packaging machine as in claim 1, where in tube (3), adjusted for introducing the foil into the longitudinal welding jaws (11), with collar (31) of tube (3) is mounted on the machine for producing bags welded on three sides (22), specifically for producing a longitudinal weld on that bag, and its longitudinal weld-creating axis is perpendicular to the axis of transverse welding jaws (12).

6. The packaging machine as in claim 1, where in tube (3) adjusted for introducing the foil into the longitudinal welding jaws (11), with collar (31) of tube (3) is mounted on the machine for producing Doy bags (23) and its longitudinal weld-creating axis is perpendicular to the axis of transverse welding jaws (12), for producing longitudinal welds on bags welded on three sides (22), with a bottom interlay added.
